(19) United States
(12) Patent Application Publication
(10) Pub. No.: US 2015/0346471 A1
(43) Pub. Date: Dec. 3, 2015

(54) METHOD FOR THE IMAGE-BASED CALIBRATION OF MULTI-CAMERA SYSTEMS WITH ADJUSTABLE FOCUS AND/OR ZOOM

(71) Applicant: Carl Zeiss Meditec AG, Jena (DE)

(72) Inventors: Oliver Schwarz, Rainau (DE); Stefan Saur, Aalen (DE); Marco Wilzbach, Stuttgart (DE); Dzianis Lamouski, Jena (DE); Matthias Berberich, Jena (DE)

(21) Appl. No.: 14/723,372

(22) Filed: May 27, 2015

(30) Foreign Application Priority Data
May 27, 2014 (DE) 10 2014 210 099.2

(51) Int. Cl. G02B 21/00; H04N 17/00; H04N 5/232; H04N 7/18

(52) U.S. Cl. CPC G02B 21/008; H04N 7/181; H04N 17/002; H04N 5/23212; H04N 5/23296

(57) ABSTRACT

The invention relates to a method for the image-based calibration of multi-camera systems with adjustable focus and/or zoom, including the following method steps: calculating a number of beams from an optics simulation for different focus and/or zoom settings or combinations of focus and zoom settings; reading out the focus and/or zoom settings and storing these values with the beams such that a unique assignment is ensured; parameterizing a continuous pinhole camera model for extrinsic and intrinsic calibration of different zoom and/or focus settings of the multi-camera system on the basis of the data from the optics simulation.

### CROSS REFERENCE TO RELATED APPLICATION

This application claims priority of German patent application no. 10 2014 210 099.2, filed May 27, 2014, the entire content of which is incorporated herein by reference.

### FIELD OF THE INVENTION

The invention relates to a method for the image-based calibration of multi-camera systems, in particular surgical microscopes with multi-camera systems, with changeable setting parameters such as focus and zoom. The goal of such a calibration lies in modeling the imaging system so as to be able to use this for a 3D reconstruction of surfaces via stereoscopic methods. Here, geometric modeling of the beam paths of the multi-camera system is paramount since these are mandatory for the 3D reconstruction.

### BACKGROUND OF THE INVENTION

A method for calibrating multi-camera systems is known, for example, from the publication “Modeling and calibration of automated zoom lenses”, PhD thesis, R. G. Wilson, The Robotics Institute, Carnegie Mellon University, Pittsburgh, Pa., 1994 (referred to as WILSON below). In order to generate a continuous model for the calibration parameters, WILSON undertakes an iterative approximation via polynomials, wherein parameters are optimized in succession and the respectively still free, non-approximated parameters are calculated in each iteration step for the recorded images using the model of the preceding iteration step. However, a disadvantage of the described method is that the basic problem of the low accuracy between the scanned positions still is present. Moreover, the calculation is implemented on the basis of only a single radial distortion coefficient. The method described in WILSON is moreover very complicated as camera matrices and distortion parameters must be determined separately for all objective settings, that is, focus and zoom settings of the surgical microscope. To this end, separate calibration recordings are required for each setting, that is, each combination of focus and zoom. Moreover, the method described in WILSON is susceptible to errors in some setting ranges since the chief rays of the objective system extend virtually parallel in the case of high zoom settings. Small lateral errors of the calibration points detected in the image can already lead to large deviations in the calculated calibration data (camera matrices, distortion parameters, rotation, translation). It is for this reason that the described solution method is numerically unstable since there may be a number of combinations of calibration parameters that lead to similar values of the cost function. Finally, the method described in WILSON has an insufficient calibration accuracy at setting positions outside of the scanned setting range. In general, strong deviations between adjacent zoom or focus settings in the scanned region emerge in the calculated calibration data, as a result of which objective settings that lie between the scanned setting positions cannot be determined with the same accuracy as the scanned setting positions by way of simple interpolation or approximation. Even very fine scanning of the setting range results in such variations. Finally, the process disclosed in WILSON supplies no absolutely referenceable measurement values for a subsequent 3D reconstruction.

A further method for the calibration of multi-camera systems is known from United States patent application publication 2014/0362186. In this method, no continuous model for individual parameters is determined over the setting positions, but rather distortion maps are interpolated for adjacent setting positions. A disadvantage of the method is that distortion maps are susceptible to errors at individual calibration points in the image and require much storage space since in each case an image field-filling map of 2D translation vectors (vector field modeling) must be stored for very many possible setting positions of the surgical microscope. Vector field models for distortion also have a 2D rotation and translation as free parameters, that is, there is ambiguity in the representation. In United States patent application publication 2014/0362186, this is solved by virtue of the calibration being performed in two steps using different calibration objects. In the first step, a calibration is performed at a single setting position (reference-setting “S0”) according to the “pinhole camera and radial distortion” model, for the purposes of which a 3D calibration object is required. In the second step, the distortion maps are established for many setting positions. This process is very complicated since the extrinsic calibration firstly is based on the naturally lower accuracies of the first calibration step, but no precise distortion maps are known during the calibration process in the first step. Moreover, no explicit camera images are specified for setting positions outside of the reference-setting, and so no 3D beam geometry is calibrated there either. This means that United States patent application publication 2014/0362186 is based on an optical center of the beam paths that is fixed over the whole focus and zoom region, and so it is not applicable to surgical microscopes because the nodes of the beam paths may in part deviate significantly from one another over the focus/zoom region.

A further disadvantage of the method described in United States patent application publication 2014/0362186 is that many points of the calibration pattern detectable in the image are required for the calculation of distortion models with many parameters, with the points having to be visible in the entire image region to be calibrated. In the case of a checkerboard pattern, these are, for example, the corners of the boxes; in the case of a point pattern, these are the centroids of the points themselves. Since an overall magnification in surgical microscopes varies strongly over the focus and zoom region, many such calibration patterns with in each case different element sizes and element spaces are required. In a correspondingly weakened form, this likewise applies to WILSON.

### SUMMARY OF THE INVENTION

It is an object of the invention to provide a method for image-based calibration of multi-camera systems, which is distinguished by a high accuracy of the calibrated beam paths in the object space over the whole setting range (in particular focus and zoom region). Moreover, the method should be distinguished by good robustness, that is, correct establishment of the parameters, even in the edge regions of the setting positions, and by stability and good manageability. In particular, a method should be provided which enables a stable calibration in a simple process with few recordings and while taking into account a small number of setting positions, the intention being only to resort to a small number of different calibration objects.

The object is achieved by a method for the image-based calibration of multi-camera systems with adjustable focus and/or zoom, the method includes the following method steps: calculating a number of beams from an optics simulation for different focus and/or zoom settings or combinations of focus and zoom settings; reading out the focus and/or zoom settings and storing these values with the beams such that a unique assignment is ensured; parameterizing a continuous pinhole camera model for extrinsic and intrinsic calibration of different zoom and/or focus settings of the multi-camera system on the basis of the data from the optics simulation.

In one embodiment of the invention, a parameterization of a continuous pinhole camera model for extrinsic calibration is implemented from image data of a calibration object for a plurality of focus and/or zoom positions of the multi-camera system.

In a further embodiment of the invention, calibration data for the focus and zoom settings are calculated via an evaluation function from the given parameters of the continuous model for intrinsic and extrinsic calibration and from focus and/or zoom settings set at the multi-camera system.

### BRIEF DESCRIPTION OF THE DRAWINGS

The invention will now be described with reference to the drawings wherein:

FIG. 1 shows a microscope for carrying out the method according to the invention;

FIG. 2 shows a flowchart of a first embodiment for the method according to the invention;

FIG. 3 shows an embodiment for a calibration sequence;

FIG. 4 shows an embodiment for a calibration body; and,

FIG. 5 shows further embodiments for calibration bodies.

### DESCRIPTION OF THE PREFERRED EMBODIMENTS OF THE INVENTION

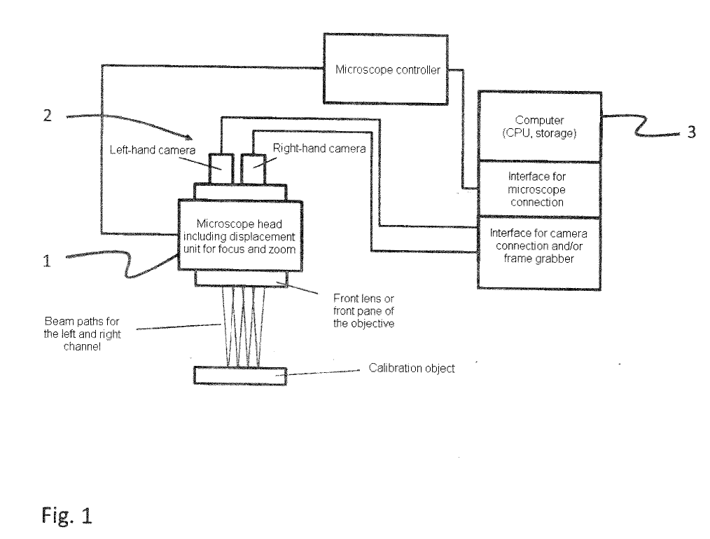

FIG. 1 depicts a surgical microscope system with a stereo surgical microscope 1 and a stereo camera system 2. The surgical microscope system includes a computer 3 with a data link to the surgical microscope, for example in the form of a frame grabber or a direct wired connection, or by way of a computer interface such as GigE or USB.

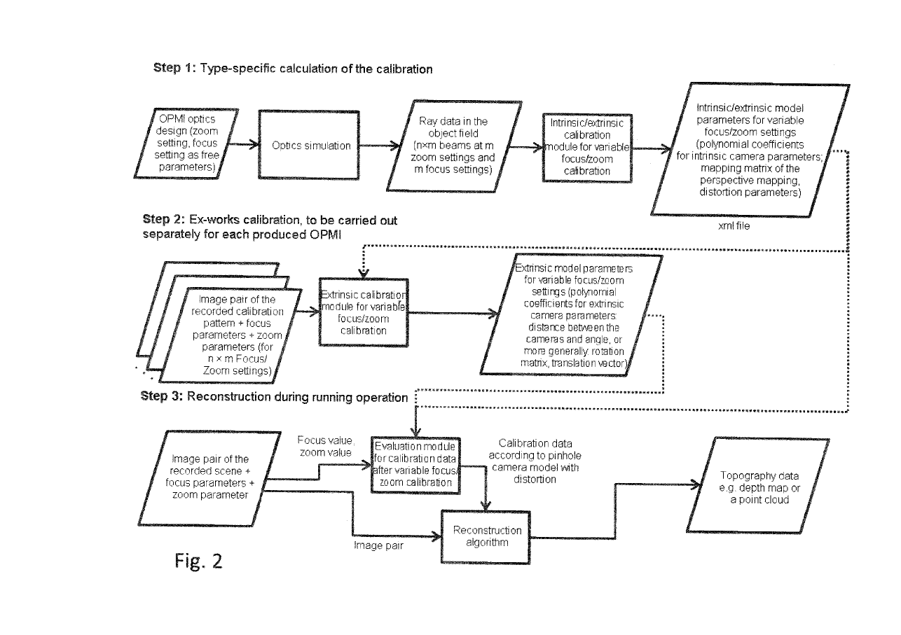

FIG. 2 depicts a flowchart of a first embodiment for a method according to the invention. In the method, data from the optics simulation, settings of the surgical microscope and real image recordings using the surgical microscope to be calibrated are combined into one workflow, in which the optics simulation forms the basis for the intrinsic calibration, that is, the determination of the camera parameters for the pinhole camera model and the parameters of the distortion mapping, in order thus to increase the accuracy and robustness of a beam reconstruction.

To this end, focus and zoom positions of the surgical microscope are established with the aid of the interface for each calibration recording and for each subsequent recording of image pairs for the reconstruction and stored together with the image data such that a unique assignment is ensured.

The parameters of the optical system of the microscope, such as positions, radii, the refractive indices of all the employed optical components and lenses, are known from an optics design model. These models are parameterizable, that is, it is possible to displace assemblies on the basis of setting parameters. In the present embodiment, the optical system is determined by the following parameters: focus and zoom. A beam in the object space is calculable for each setting position from the parameters of the optical system with the aid of a simulation program. Usually, this is implemented via a ray tracing process. As a result, a beam is obtained which describes the geometric image for each camera pixel, that is, the associated visual beam in the object space in front of the microscope for each camera pixel. Here, visual beams can be determined in each case by, for example, reference point and direction vector in space. In one embodiment of the invention, this information is not established for each individual camera pixel, but, for reasons of calculation time, the camera image is scanned such that visual beams are determined for selected pixel positions in the camera image.

In the first step, beams for a number of setting positions are calculated for a given optics design and setting range of the surgical microscope, that is, there is very fine scanning within the setting range of the surgical microscope with the goal of determining intrinsic and extrinsic parameters for a pinhole camera model with distortion therefrom.

Here, the pinhole camera model with is defined as a mapping of 3D points in the object space (space in front of the microscope) to the image space (pixel coordinates of the camera) by means of

(1) a transformation mapping in space, including rotation and translation, via which a reference coordinate system of the simulated beams can be converted into a camera coordinate system including an optical axis and an optical center according to the pinhole camera model,

(2) a central projection along beams through the origin (0,0,0) of the camera coordinate system (optical center) into a virtual plane at the distance z=1 from the origin,

(3) a distortion mapping D with distortion parameters (d1, . . . , dₖ), and

(4) an affine mapping with the camera matrix K in homogeneous coordinates

$$K = ( \begin{matrix}fx & s & u 0 \\ 0 & fy & v 0 \\ 0 & 0 & 1\end{matrix} )$$

with the following parameters: optical center in the image (u0, v0), magnification factors fx and fy in x- and y-direction, respectively, and the shear (s), distortion coefficients k1, . . . , kn and, as extrinsic parameters, three angles of rotation which uniquely describe a 3×3 rotation matrix and a translation vector with three translation parameters.

Here, the distortion mapping can be implemented by way of models of radial and tangential distortion, as is known from machine vision, or, as described in United States patent application publication 2014/0362186, by way of a distortion map, that is, a vector field model. A very large number of parameters are required for encoding the distortion mapping for distortion maps, in the extreme case the x- and y-stacks for each image pixel of the camera image. Encoding of the distortion in the form of coefficients of suitable base functions, for example, polynomial functions, in 2 variables (for example, 2D tensor product) or in the form of B-splines (base functions of a polynomial spline space) is less storage intensive.

A set of parameters of the pinhole camera model with distortion is calculated for each beam from the optics simulation, and so visual beams, associated with camera pixels, in the object region of interest approximate the beams from the optics simulation to the best possible extent, that is, with the smallest possible deviation between the approximated and simulated beams according to a geometric error measure in the space. By way of example, the quality of the approximation can be optimized by a minimization according to the least-squares method or by a minimization of the maximum distance or any other metric, in each case via processes from nonlinear optimization.

Subsequently, parameters of a continuous model are calculated over all zoom and focus settings for each free camera parameter of the pinhole camera model and for each distortion parameter. Here, the continuous model can be defined as, for example, a polynomial function or spline function, which assigns such a model parameter to each combination of focus and zoom value.

In the case of a given intrinsic calibration and a given focus position, there subsequently is an extrinsic calibration. In a stereo system, for this purpose a transformation mapping is typically encoded between the two camera systems via a rotation matrix and a translation vector, for which 6 free parameters are required. However, in the present embodiment, it is sufficient only to encode the deviation from the extrinsic calibration on the basis of the simulated data, which can be implemented with substantially fewer parameters. In the present case, a base spacing between the two camera positions as a function of the focus position suffices as only free parameter. From this, a continuous representation with few parameters is calculated, preferably via an approximation with a polynomial or spline model.

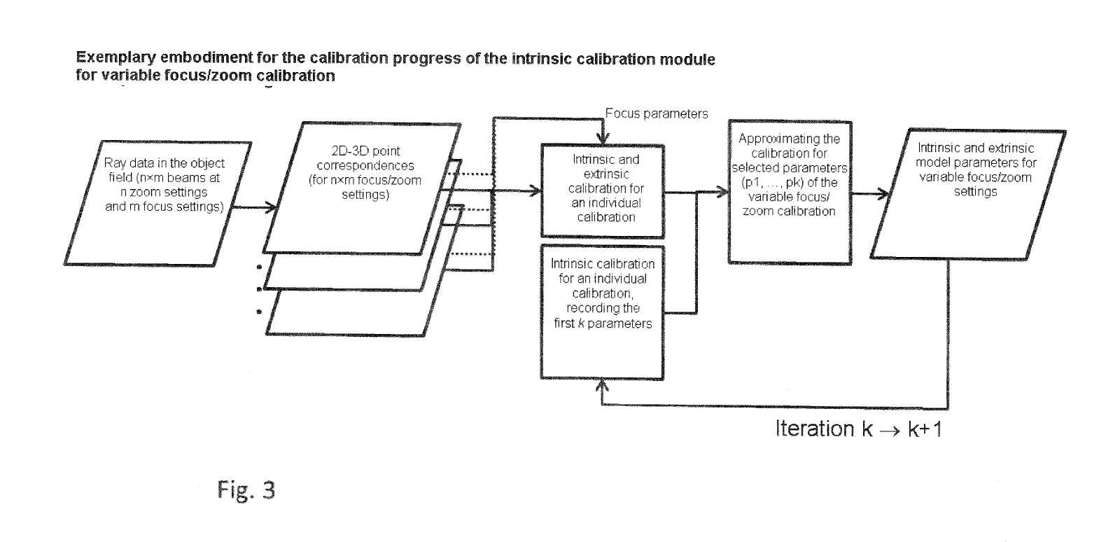

In one application, for example when performing a 3D reconstruction for an image pair of the surgical microscope, an intrinsic and extrinsic calibration is calculated via an evaluation module from the parameters of the continuous representation of the calibration in the case of a given image pair and a given zoom and focus value. To this end, the respective representation for each calibration parameter is evaluated according to the pinhole camera model with distortion (FIG. 3).

For calibration purposes, a calibration object with features or patterns, which are visible in both camera images, is required for each focus and zoom setting. In the case of an appropriate configuration, the same calibration object can also be used for a plurality of focus and zoom settings with a similar overall magnification. By way of example, suitable calibration objects can be configured as a set of planar checkerboard patterns.

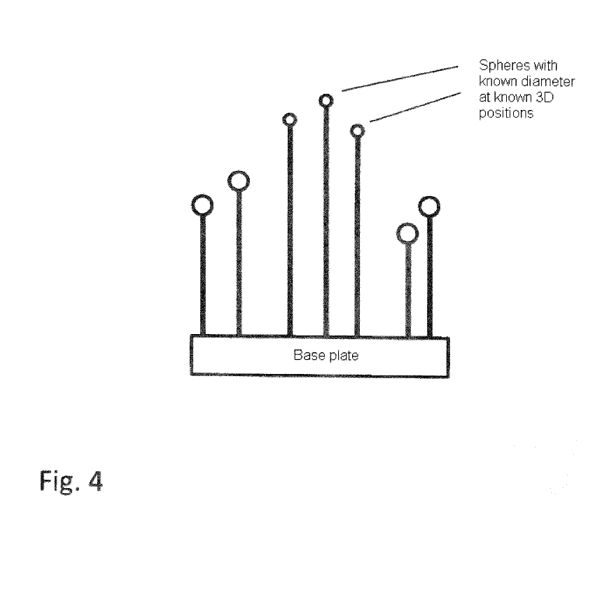

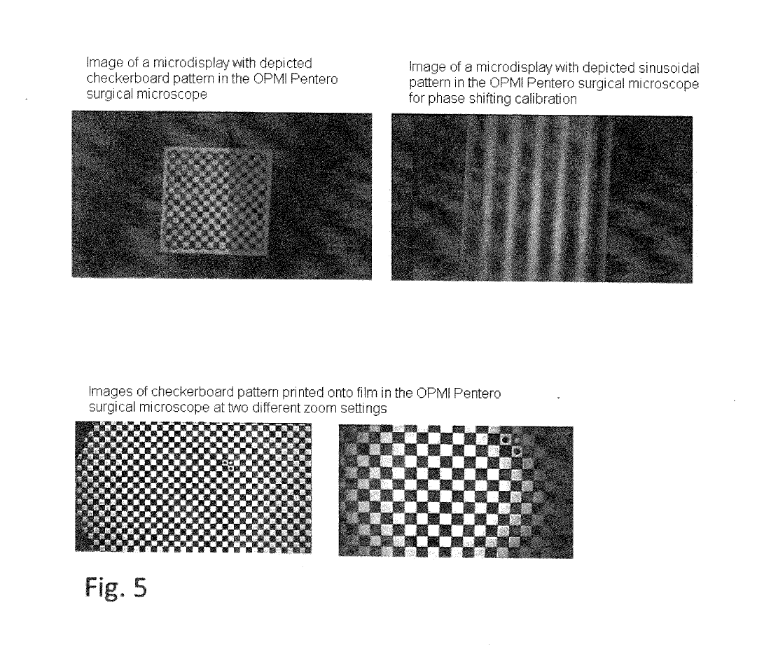

Any patterns for calibration objects that are evaluable by the image processing can be used as a pattern for calibration objects (FIGS. 4 and 5). A unique assignment of position and orientation of the pattern in the image to the 3D geometry of the pattern is necessary for the extrinsic calibration. To this end, specific, uniquely assignable regions are attached to the pattern. By way of example, a 3-point marker was used in FIG. 5.

Furthermore, an even glass plate or masks with a predetermined pattern on a transparent film, which were generated via a laser photoplotter, are also conceivable. An advantage of such calibration objects consists of the fact that, in the case of transmission viewing of the pattern, no cast shadows of the pattern and therefore no shadow-dependent edge shifts occur between the two image channels (left/right channel of the stereo surgical microscope).

In a further embodiment, a display, for example, a TFT or LCD display or micro display, with an adjustable spatial frequency of the depicted pattern is used as the calibration object. Here, sinusoidal intensity profiles with an adjustable wavelength are depicted on the display. The advantage offered by this embodiment is that it is possible to calculate a unique assignment of the observed pixels in the camera image to real 3D positions on the display with sub-pixel accuracy with the aid of very many phase-shifted recordings with a plurality of wavelengths. To this end, phase shift algorithms, as are conventional in deflectometry, are used. The viewing pane (front glass pane) of the display should in this case have a known and constant thickness, great evenness and a known refractive index.

In further embodiments, the calibration object is provided as an anodized metal plate with great evenness and bores at known positions. In the case of a planar calibration object, there preferably is a displacement unit in the z-direction of the optics system in order to be able to undertake a calibration over the complete zoom/focus range of the surgical microscope.

3D calibration objects for extrinsic calibrations, via which many focus and zoom settings can be calibrated without a displacement unit being mandatory, are also conceivable. By way of example, such 3D calibration objects can be configured in a layered manner with planar patterns in a number of planes. Alternatively, they can also be embodied as spheres with known diameter at different heights on rods (multi-sphere target, FIG. 5). The advantage of these 3D calibration objects lies in the fact that the spheres are also detectable in the case of out-of-focus imaging in the camera image via a circle fitting or centroid process (in the case of small spheres), and so the positions can be determined with subpixel accuracy. A precondition for this is a sufficient contrast between the sphere and background (color of the sphere in relation to the color of the base plate).

The invention is distinguished by a combination of simulation, reading out the focus parameter and few recordings for the extrinsic calibration, with the goal of configuring the calibration to be more exact and less susceptible to errors. As is clear from FIG. 2, the intrinsic calibration is formed on the basis of simulated ray data of the chief or the centroid rays of the optics system. It is also possible to calculate the distortion parameters very exactly from the ray data. To this end, the deviation of the calculated rays of the pinhole camera model with distortion from the given rays from the simulation is minimized according to a geometric error measure.

It is understood that the foregoing description is that of the preferred embodiments of the invention and that various changes and modifications may be made thereto without departing from the spirit and scope of the invention as defined in the appended claims.

What is claimed is:

1. A method for image-based calibration of multi-camera systems with at least one of adjustable focus and adjustable zoom, the method comprising the steps of:
calculating a number of beams from an optics simulation for at least one of different focus settings and different zoom settings;
reading out the at least one of focus settings and zoom settings and storing these values with the beams such that an unambiguous allocation is ensured; and,
parameterizing a continuous pinhole camera model for extrinsic and intrinsic calibration of at least one of different zoom settings and different focus settings of the multi-camera system on the basis of the data from the optics simulation.

2. The method of claim 1, wherein said parameterizing of a continuous pinhole camera model for extrinsic and intrinsic calibration is performed from image data of a calibration object for a plurality of at least one of focus positions and zoom positions of the multi-camera system.

3. The method of claim 2 further comprising the step of calculating calibration data for the focus and zoom settings via an evaluation function from the given parameters of the continuous model for intrinsic and extrinsic calibration and from at least one of the focus setting and the zoom settings set at the multi-camera system.

4. A method for image-based calibration of multi-camera systems with at least one of adjustable focus and adjustable zoom, the method comprising the steps of:
calculating a number of beams from an optics simulation for different combinations of focus and zoom settings;
reading out the focus setting and zoom settings and storing these values with the beams such that an unambiguous allocation is ensured; and,
parameterizing a continuous pinhole camera model for extrinsic and intrinsic calibration of at least one of different zoom settings and different focus setting of the multi-camera system on the basis of the data from the optics simulation.

5. The method of claim 4, wherein said parameterizing of a continuous pinhole camera model for extrinsic and intrinsic calibration is performed from image data of a calibration object for a plurality of at least one of focus and zoom positions of the multi-camera system.

6. The method of claim 4 further comprising the step of calculating calibration data for the focus and zoom settings via an evaluation function from the given parameters of the continuous model for intrinsic and extrinsic calibration and from at least one of the focus setting and the zoom settings set at the multi-camera system.
